(19) United States
(12) Patent Application Publication
(10) Pub. No.: US 2017/0327424 A1
(43) Pub. Date: Nov. 16, 2017

(54) Construction Panel Having Improved Fixing Strength

(71) Applicant: Saint-Gobain Placo SAS, Suresnes (FR)

(72) Inventors: Laura Brooks, Loughborough (GB); Nicola Jupp, Coventry (GB); Joanna Sparkes, Coventry (GB); Adam Richardson, Coventry (GB); Jan Rideout, Rothley (GB); Nicolas Jones, Coventry (GB)

(21) Appl. No.: 15/527,731

(22) PCT Filed: Nov. 19, 2015
(86) PCT No.: PCT/GB2015/053539

§ 371 Date: May 18, 2017

(30) Foreign Application Priority Data
Nov. 20, 2014 (GB) 1420677.5

(51) Int. Cl. C04B 28/14; C04B 14/42

(52) U.S. Cl. CPC C04B 28/14; C04B 14/42

(57) ABSTRACT

A method of producing a gypsum product comprises the steps of: □preparing a stucco slurry; □adding starch-containing flour to the slurry in an amount of at least 2% relative to the dry weight of the stucco; and □allowing the stucco slurry to set.

### FIELD OF THE INVENTION

The present invention relates to panels for use in building construction. In particular, the present invention relates to panels for providing partitions to which items such as sinks, televisions, or radiators may be affixed.

### BACKGROUND TO THE INVENTION

Light-weight panels such as plasterboard (e.g. gypsum plasterboard), polystyrene board and fibreboard are commonly used to provide partitions within buildings. Their advantages for this application include the fact that they are light and quick to install.

However, in certain cases, such light-weight panels may have the drawback that they are not strong enough to support fixtures (e.g. sinks, televisions, radiators, fire extinguishers, shelves and any other item that requires attachment to the panel). In such cases, the weight of the fixture may cause the fixing means (e.g. screws) to be pulled out of the panel, such that the fixture falls away from the partition.

Typically, this problem has been addressed by providing plywood sheets to increase the fixing strength of the panel. In this case, the plywood sheet is provided on the side of the panel opposite to that on which the fixture is to be located. The plywood sheet may provide increased strength for retaining one or more fixing means (e.g. screws) employed to secure the fixture to the panel. Typically, the plywood sheet is positioned within the partition framework, and the plasterboard then fixed to the plywood, so that it lies outside the partition framework.

As an alternative, metal support means may be provided. These may comprise fixing plates, channels, straps, or metal fasteners. As is the case for plywood sheets, the metal support means are generally positioned on the side of the panel opposite that to which the fixture is to be secured, and act to receive and secure fixing means, e.g. fixing screws, that are used to attach the fixture to the panel.

Both these arrangements have the disadvantage that they require the panels and the additional supporting components to be affixed to each other on-site. Moreover, when metal support means are used, a plurality of such support means may be needed to support the full set of fixing means required to secure the fixture to the panel. Thus, the installation process may be time-consuming and expensive.

Furthermore, the addition of metal support means or plywood sheets increases the weight and thickness of the partition, and/or results in a reduction in cavity wall space. In general, the plywood itself must be cut to size on site, thus increasing the time required for installation and possibly leading to the release of dust and potentially harmful components.

Therefore, there is a need to provide improved panels that are able to retain fixing means and support fixtures, and that do not require time-consuming installation processes.

### SUMMARY OF THE INVENTION

Investigations have been carried out into the use of polymeric additives to strengthen gypsum products. Surprisingly, it has been found that by incorporating flour into the stucco slurry used to produce the gypsum product, certain advantages in the manufacture and performance of gypsum products may be achieved.

Therefore, in a first aspect, the present invention may provide a method of producing a gypsum product comprising the steps of:
preparing a stucco slurry;
adding flour to the slurry in an amount of at least 2% relative to the dry weight of the stucco; and
allowing the stucco slurry to set.

It has been found that by incorporating flour into a stucco slurry, a more fluid slurry may be provided than is the case when using conventional starch that has been extracted from plant matter (for example, by being washed out from the plant matter). As a result, manufacture of the gypsum product may become easier. In certain cases, it has been found that gypsum products produced according to this method exhibit reduced levels of expansion when exposed to a humid atmosphere. One or both of these advantages may be achieved while retaining acceptable mechanical performance in the gypsum product.

Typically, the flour is added in an amount of at least 4%, preferably at least 5% relative to the dry weight of the stucco.

In general, the flour is a starch-containing flour such as wheat flour, rice flour, tapioca flour, potato flour, or corn flour.

Typically, the method further comprises the step of adding fibres to the slurry, for example, glass fibres. Typically, the fibres are added in an amount of at least 1% relative to the dry weight of the stucco, preferably at least 1.5%

The method may be used to produce a plasterboard.

It is thought that the enhanced performance of flour relative to conventional starch may be due to the presence of gluten in the flour.

Therefore, in a second aspect, the present invention may provide a method of producing a gypsum product comprising the steps of:
preparing a stucco slurry;
adding gluten and starch to the slurry as separate additives; and
allowing the stucco slurry to set.

In the first and second aspects of the invention, the term “stucco slurry” refers to a settable slurry in which the principal hydratable solid is calcium sulphate (for example, calcium sulphate hemihydrate and/or calcium sulphate anhydrite).

### DETAILED DESCRIPTION

The invention will now be described by way of example only.

Gypsum plasterboards were prepared using the following general methodology:

Stucco and other dry additives were weighed into a bag and shaken to mix them. Water and wet additives were weighed into a bowl and mixed using an electric mixer for 60 s.

The dry powdered additives were added to the wet additives in the bowl and mixed in with the electric mixer for 30 s.

The resultant slurry was sandwiched between two sheets of paper liner and allowed to hydrate for 25 minutes measured from the time of mixing. The board was then dried in an oven for 1 hour at 160° C.

The board thickness was 12.5 mm and the board density was 950 kg/m³.

### EXAMPLE 1

A gypsum plasterboard was prepared from a slurry containing the following ingredients:
stucco;
wheat flour from Jackering in an amount of 6 wt % relative to the stucco;
glass fibre in an amount of 2 wt % relative to the stucco.

### COMPARATIVE EXAMPLE 1

A gypsum plasterboard was prepared from a slurry containing the following ingredients:
stucco;
corn starch (trade name: Merifilm) in an amount of 6 wt % relative to the stucco;
glass fibre in an amount of 2 wt % relative to the stucco.

Fluidity

It was observed that the slurry prepared during Example 1 was more fluid than that prepared during Comparative Example 1.

Expansion with Humidity

Expansion with humidity was measured according to ASTM D1037 from initial conditions of 23° C. and 50% relative humidity to final conditions of 20° C. and 90% relative humidity. The samples were 200 mm long and 50 mm thick. The results are set out in Table 1.

TABLE 1

| | Expansion |
|---|---|
| Example | with humidity |
| Example 1 | 0.052 |
| Comparative | 0.071 |
| example 1 | |

Screw Pull-Out Strength

Screw pull-out tests were carried out on samples measuring 100 mm by 100 mm that had been conditioned at a temperature of 23° C. and a relative humidity of 50%. A 50 mm single thread wood screw was inserted into the sample, passing through a metal load transfer element positioned on the surface of the sample. The load transfer element has a first portion that is configured to lie between the screw head and the surface of the sample, and a second portion that is configured to engage with a testing machine so as to allow a load to be applied to the screw along the axis of the screw. The screw was tightened to a torque of 1 Nm.

The specimen was then mounted in a Zwick Universal Testing Machine and a 10N pre-load applied to the screw along the axis of the screw. Subsequently, the load was increased by setting a constant cross-head speed of 10 mm/minute until pull out was achieved.

The results are set out in Table 2. These are averages, each taken from 8 samples.

TABLE 2

| | Average screw |
|---|---|
| | pull-out |
| Example | strength N |
| Example 1 | 561 ± 58 |
| Comparative | 606 ± 65 |
| example 1 | |

1. A method of producing a gypsum product comprising the steps of:
preparing a stucco slurry;
adding starch-containing flour to the slurry in an amount of at least 2% relative to the dry weight of the stucco; and
allowing the stucco slurry to set.

2. A method according to claim 1, wherein the flour is added in an amount of at least 4% relative to the dry weight of the stucco.

3. A method according to claim 1, wherein the flour is wheat flour.

4. A method according to claim 1, further comprising the step of adding fibres to the slurry.

5. A method according to claim 4, wherein the fibres are glass fibres.

6. A method according to claim 4, wherein the fibres are added in an amount of at least 1% relative to the dry weight of the stucco.
